(19) United States
(12) Patent Application Publication
(10) Pub. No.: US 2026/0195368 A1
(43) Pub. Date: Jul. 9, 2026

(54) SYSTEMS AND METHODS FOR PRODUCING CONFIDENCE SCORES FOR REPLIES FROM MACHINE LEARNING MODELS

(71) Applicant: Instabase, Inc., Dover, DE (US)

(72) Inventors: Nikolaos Kofinas, Seattle, WA (US); Slawomir Jan Biel, Warsaw (PL)

(21) Appl. No.: 19/012,620

(22) Filed: Jan. 7, 2025

(51) Int. Cl. G06F 16/383; G06F 16/338; G06F 40/284

(52) U.S. Cl. CPC G06F 16/383; G06F 16/338; G06F 40/284

(57) ABSTRACT

Systems and methods to produce confidence scores for replies from one or more machine learning models are disclosed. Exemplary implementations may receive user input representing a query from a user, wherein the query requests a first item of information; generate prompt information defining a prompt based on the query; provide the prompt as input to one or more machine learning models; obtain a reply including a set of tokens and a corresponding set of probabilities that corresponds to the set of tokens; determine a subset of tokens that correspond to the first item; determine a first confidence score based on the individual probabilities of the subset of tokens; and present the reply and the first confidence score.

### FIELD OF THE DISCLOSURE

The present disclosure relates to systems and methods for producing confidence scores for replies from machine learning models.

### BACKGROUND

Extracting information from electronic documents is known. Presenting information in user interfaces is known. Large language models and other machine learning models are known.

### SUMMARY

By virtue of the systems and methods described herein, the process of extracting information from documents is improved by producing and presenting confidence scores along with the replies from machine learning models. Specifically, the confidence scores are based on certain probabilities of certain tokens that are generated by the machine learning models, which helps the users to interpret the information provided by the machine learning models, whether identified, determined, extracted, and/or otherwise inferred from, e.g., source documents and/or other information. These improvements enable the user of the machine learning models to more efficiently and more accurately perform tasks.

One aspect of the present disclosure relates to a system configured to produce confidence scores for replies from one or more machine learning models. The system may include electronic storage, one or more hardware processors configured by machine-readable instructions, and/or other components. The system may be configured to receive user input representing a query from a user, wherein the query requests a first item of information. The system may be configured to generate prompt information defining a prompt based on the query. The system may be configured to provide the prompt as input to one or more machine learning models. The system may be configured to obtain a reply including a set of tokens and a corresponding set of probabilities that corresponds to the set of tokens. The system may be configured to determine a subset of tokens that correspond to the first item. The system may be configured to determine a first confidence score based on the individual probabilities of the subset of tokens. The system may be configured to present the reply and the first confidence score, and/or perform other steps.

One aspect of the present disclosure related to a method of producing confidence scores for replies from one or more machine learning models. The method may include receiving user input representing a query from a user, wherein the query requests a first item of information. The method may include generating prompt information defining a prompt based on the query. The method may include providing the prompt as input to one or more machine learning models. The method may include obtaining a reply including a set of tokens and a corresponding set of probabilities that corresponds to the set of tokens. The method may include determining a subset of tokens that correspond to the first item. The method may include determining a first confidence score based on the individual probabilities of the subset of tokens. The method may include presenting the reply and the first confidence score, and/or perform other steps.

As used herein, any association (or relation, or reflection, or indication, or correspondency) involving servers, processors, client computing platforms, documents, machine learning models, presentations, extracted information, classifications, user interfaces, user interface elements, user input, interface fields, interface portions, queries, prompts, replies, tokens, probabilities, scores, metrics, representations, and/or another entity or object that interacts with any part of the system and/or plays a part in the operation of the system, may be a one-to-one association, a one-to-many association, a many-to-one association, and/or a many-to-many association or “N” to-“M” association (note that “N” and “M” may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, extract, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to produce confidence scores for replies from one or more machine learning models.

FIG. 2 illustrates a method of producing confidence scores for replies from one or more machine learning models.

FIG. 3 illustrates a method of producing confidence scores for replies from one or more machine learning models.

FIG. 4 illustrates an exemplary electronic document as may be used in a system configured to produce confidence scores for replies from one or more machine learning models.

### DETAILED DESCRIPTION

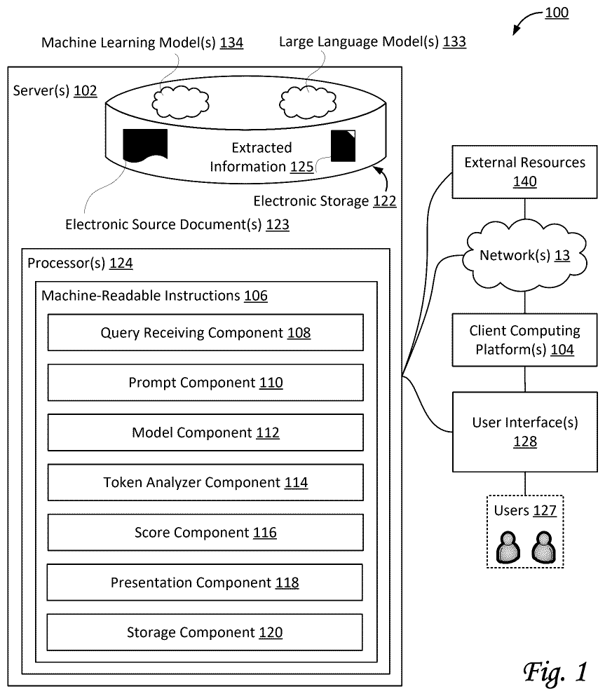

FIG. 1 illustrates a system 100 configured to produce confidence scores for replies from one or more machine learning models 134, in accordance with one or more implementations. One or more machine learning models 134 may include a large language model 133, also depicted in FIG. 1. In some implementations, system 100 may include one or more servers 102, electronic storage 122, one or more processors 124, one or more client computing platforms 104, one or more user interfaces 128, external resources 140, one or more machine learning models 134 (e.g., one or more large language models 133), and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures.

Users 127 may access system 100 via client computing platform(s) 104. In some implementations, individual users may be associated with individual client computing platforms 104. For example, a first user may be associated with a first client computing platform 104, a second user may be associated with a second client computing platform 104, and so forth. In some implementations, individual user interfaces 128 may be associated with individual client computing platforms 104. For example, a first user interface 128 may be associated with a first client computing platform 104, a second user interface 128 may be associated with a second client computing platform 104, and so forth.

By virtue of the systems and methods disclosed herein, a user may use one or more machine learning models 134 (e.g., a machine learning model such as large language model 133) to request information to be provided (e.g., extracted from and/or otherwise based on a particular electronic source document 123) and subsequently presented to the user, along with particular information (referred to as a confidence score) that represents with how much confidence and/or probability one or more machine learning models 134 generated pertinent parts of the requested information.

As used herein, the term “extract” and its variants refer to the process of identifying and/or interpreting information that is included in one or more documents and/or based on content of the one or more documents, whether performed by determining, measuring, calculating, computing, estimating, approximating, interpreting, generating, and/or otherwise deriving the information, and/or any combination thereof. In some implementations, extracted information may have a semantic meaning, including but not limited to opinions, judgement, classification, and/or other meaning that may be attributed to (human and/or machine-powered) interpretation. For example, in some implementations, some types of extracted information need not literally be included in a particular electronic source document, but may be a conclusion, classification, and/or other type of result of (human and/or machine-powered) interpretation of the contents of the particular electronic source document.

Alternatively, and/or simultaneously, extracted information may be extracted by a document analysis process that uses machine-learning (in particular deep learning) techniques. For example, a large language model such as large language model 133 may be used. For example, (deep learning-based) computer vision technology may be used. For example, a convolutional neural network may have been trained and used to classify (pixelated) image data as characters, photographs, diagrams, media content, and/or other types of information. In some implementations, the extracted information may be extracted by a document analysis process that uses a pipeline of steps for object detection, object recognition, and/or object classification. In some implementations, the extracted information may be extracted by a document analysis process that uses one or more of rule-based systems, regular expressions, deterministic extraction methods, stochastic extraction methods, and/or other techniques. In some implementations, particular document analysis processes that are used to extract certain information may fall outside of the scope of this disclosure, and the results of these particular document analysis processes, e.g., the extracted information, may be obtained and/or retrieved by a component of system 100.

Server(s) 102 may be configured by machine-readable instructions 106. Machine-readable instructions 106 may include one or more instruction components. The instruction components may include computer program components. The instruction components may include one or more of a query receiving component 108, a prompt component 110, a model component 112, a token analyzer component 114, a score component 116, a presentation component 118, a storage component 120, and/or other instruction components.

Machine-readable instructions 106 may enable system server(s) 102 to obtain, access, use, and/or fine-tune one or more machine learning models 134, including but not limited to one or more large language models 133. In some implementations, individual large language models 133 may include and/or be based on a neural network using over a billion parameters and/or weights. In some implementations, machine-readable instructions 106 may enable system server(s) 102 to fine-tune one or more large language models 133 through a set of documents (e.g., training documents). In some cases, the training documents may include financial documents, including but not limited to bank statements, insurance documents, mortgage documents, loan documents, annual reports, invoices, and/or other financial documents. In some implementations, individual large language models 133 may have been trained on at least a million documents. In some implementations, individual large language models 133 may have been trained on at least 100 million documents.

In some implementations, individual large language models 133 may be based on Generative Pre-trained Transformer 3(GPT3). In some implementations, individual large language models 133 may be based on ChatGPT, as developed by OpenAI™. In some implementations, individual large language models 133 may be derived from Generative Pre-trained Transformer 3 (GPT3) or a successor of Generative Pre-trained Transformer 3 (GPT3). In some implementations, large language model 133 may be (derived from) Generative Pre-trained Transformer 3 (GPT3) or a successor of Generative Pre-trained Transformer 3 (GPT3). In some implementations, large language model 133 may be (derived from) Large Language Model Meta AI (LLAMA) by META™, or a successor. In some implementations, large language model 133 may be (derived from) PALM2™ by GOOGLE™, or a successor.

By way of non-limiting example, the terms “document,” “electronic document,” “electronic source document,” and derivatives thereof, may be used interchangeably. For example, a set of documents may be provided as input and/or context for a prompt provided to one or more machine learning models 134. By way of non-limiting example, the electronic formats of any (electronic) documents 123 may be one or more of Portable Document Format (PDF), Portable Network Graphics (PNG), Tagged Image File Format (TIF or TIFF), Joint Photographic Experts Group (JPG or JPEG), and/or other formats. Electronic documents 123 may be stored (e.g., in electronic storage 122) and obtained as electronic files.

In some implementations, an electronic document may be a scanned and/or photographed version of an original paper document and/or otherwise physical original document, or a copy of an original digital document. In some implementations, original documents may have been published, generated, produced, communicated, and/or made available by a business entity and/or government agency. Business entities may include corporate entities, non-corporate entities, and/or other entities. For example, an original document may have been communicated to customers, clients, and/or other interested parties. By way of non-limiting example, a particular original document may have been communicated by a financial institution to an account holder, by an insurance company to a policy holder or affected party, by a department of motor vehicles to a driver, etc. In some implementations, original documents may include financial reports, financial records, and/or other financial documents. As used herein, documents may be referred to as “source documents” when the documents are originally published, generated, produced, communicated, and/or made available, or when the documents are copies thereof. Alternatively, and/or simultaneously, documents may be referred to as “source documents” when the documents are a source of human-readable information, a basis for human-readable information, and/or a container for human-readable information.

In some implementations, one or more electronic formats used for electronic documents 123 may encode visual information that represents human-readable information, such as characters, words, dates, amounts, phrases, tables, etc. In some implementations, one or more electronic formats used for the electronic documents may be such that, upon presentation of the electronic documents through user interface(s) 128, the presentation(s) include human-readable information. By way of non-limiting example, human-readable information may include any combination of numbers, letters, diacritics, symbols, punctuation, and/or other information (jointly referred to herein as “characters”), which may be in any combination of alphabets, syllabaries, and/or logographic systems. In some implementations, characters may be grouped and/or otherwise organized into groups of characters (e.g., any word in this disclosure may be an example of a group of characters, particularly a group of alphanumerical characters). For example, a particular electronic source document 123 may include multiple groups of characters, such as, e.g., a first group of characters, a second group of characters, a third group of characters, a fourth group of characters, and so forth.

The electronic formats may be suitable and/or intended for human readers, and not, for example, a binary format that is not suitable for human readers. For example, the electronic format referred to as “PDF” is suitable and intended for human readers when presented using a particular application (e.g., an application referred to as a “PDF reader”). In some implementations, particular electronic source document 123 may represent one or more of a bank statement, a financial record, a photocopy of a physical document from a government agency, and/or other documents. For example, a particular electronic source document 123 may include a captured and/or generated image and/or video. For example, a particular electronic source document 123 may be a captured and/or generated image. Individual ones of electronic documents 123 may have a particular size and/or resolution.

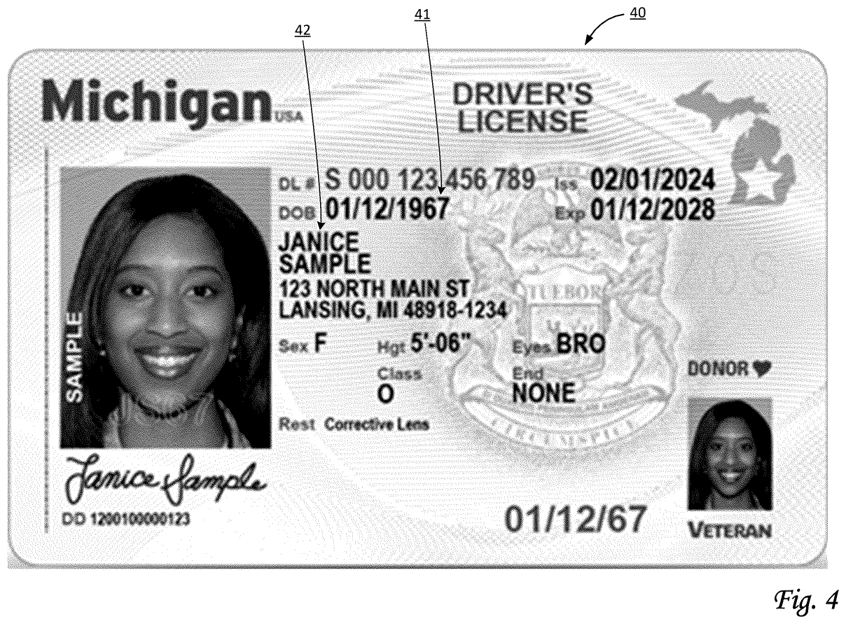

Query receiving component 108 may be configured to receive user input representing queries from users 127. In some implementations, user input may be received from one or more client computing platforms 104. Queries may request information to be provided by one or more machine learning models 134. In some implementations, queries may request information to be provided by one or more machine learning models 134 using one or more documents as context. For example, using a particular driver's license as context, a particular query may request the driver's date of birth: “What is the driver's date of birth?” In some cases, the requested information includes more than one item of information. For example, using a particular driver's license as context, a particular query may request the driver's name and date of birth, and/or additional information: “What is the driver's name and date of birth?” By way of non-limiting example, FIG. 4 illustrates an exemplary electronic document 40 (here, a photocopy of a driver's license), including a date-of-birth (DOB) 41 (of “01-12-1967” or Jan. 12, 1967) and a driver's name 42 (of “JANICE SAMPLE”).

Referring to FIG. 1, by way of non-limiting example, user input representing a particular query may be received through user interface 128 on client computing platform 104 (e.g., a client device). The particular query may refer to a set of one or more documents, and/or other information. By way of non-limiting example, query receiving component 108 may be configured to receive second user input indicating a second query. For example, the second user input may be received after the user input. In some implementations, a particular user 127 may provide the user input via a particular client computing platform 104. In some implementations, one or more user interfaces 128 may be configured to obtain entry of user input from one or more users 127. Particular user 127 may provide the user input to a particular user interface 128 presented on a particular client computing platform 104. In some implementations, the user input may include selection and/or entry of one or more documents 123. In some implementations, the user input may represent one or more queries. By way of non-limiting example, a user may select and/or enter one or more particular documents in association with one or more queries. In some implementations, user interface 128 may depict one or more (selected) documents. For example, a user may navigate through documents using user interface 128. In some implementations, particular user interface 128 may include a chat interface enabling one or more users 127 to “converse” with (or about) one or more documents 123 and/or one or more machine learning models 134. In some implementations, user interface 128 may be used to obtain user input (e.g., queries), present prompts (e.g., as generated based on queries), present replies(e.g., as obtained from one or more machine learning models 134), and/or present results (e.g., confidence scores and/or other information).

By way of non-limiting example, a particular query may include a natural language question of “What is the two-year CAGR for Example Company's revenue?” and/or other information. For example, the natural language questing may have been entered via a text box presented as part of particular user interface 128. By way of non-limiting example, an item of information as requested to be provided by the particular query may be “the two-year Compound Annual Growth Rate (CAGR) for Example Company's revenue.” In some implementations, one or more documents 123 may not be explicitly included in the query. For example, individual ones of one or more documents 123 may have been entered and/or selected by the user prior to and/or after the first query being entered and/or selected.

Prompt component 110 may be configured to generate prompt information based on individual ones of the queries. The prompt information may define a prompt to be provided to one or more machine learning models 134. In some implementations, the prompt information for the individual ones of the prompts may include one or more of context, document information, the individual ones of the queries, instructions for one or more machine learning models 134, constraints for one or more machine learning models 134, and/or other information. For example, in some cases, prompt information may instruct one or more machine learning models 134 to provide probabilities along with a reply. For example, one or more machine learning models 134 may be instructed to provide individual probabilities along with individual tokens of a reply. In some cases, prompt information may specify which probability to provide. For example, individual tokens may be associated with a logarithmic probability (also referred to as “log prob”), a logit or unnormalized probability, a probability taken before the final softmax function, a probability taken after the final softmax function, and/or other probabilities. In some implementations, individual probabilities may be associated with words or phrases instead of tokens.

By way of non-limiting example, one or more of a prompt for a particular query, a second prompt for a second query, and/or other prompts may be generated. Particular prompt information for a particular query may be generated. In some cases, prompt information may include document information, such as, e.g., a set of documents. By way of non-limiting example, a set of documents may include a particular electronic document 123 indicated by a particular query, or otherwise selected by the user. In some cases, the document information for a set of one or more documents may include one or more of a summary of particular document 123, a description of particular document 123, particular document 123, text included in particular document 123, a portion of particular document 123, and/or other information.

Prompt component 110 may be configured to provide prompts as input to one or more machine learning models 134. One or more machine learning models 134 may be configured to generate replies to the prompts. Replies may include tokens, e.g., sets of tokens. For example, a particular reply may include a particular set of tokens. The replies, including tokens, are generated by one or more machine learning models 134 responsive to receipt of the prompts as input. In some implementations, a particular reply may include a particular set of tokens. The particular reply may further include probabilities, such as a set of probabilities that correspond to a set of tokens. In some cases, individual tokens in the particular set of tokens are associated with individual probabilities, e.g., probabilities of having been generated by one or more machine learning models 134. For example, prompt component 110 may provide the prompt “What is the driver's name and date of birth?” as input to large language model 133, using exemplary electronic document 40 (shown in FIG. 4) as context.

Referring to FIG. 1, model component 112 may be configured to provide prompts to one or more machine learning models 134, provide instructions to one or more machine learning models 134, obtain replies from one or more machine learning models 134, and/or otherwise interact with one or more machine learning models 134. In some implementations, replies to prompts may be obtained from one or more machine learning models 134 by model component 112. For example, a reply may include a set of tokens and a corresponding set of probabilities that corresponds to the set of tokens. In some cases, one or more machine learning models 134 may be included in system 100. In other cases, model component 112 and/or other components of system 100 may interact with external machine learning models 134, e.g., through Application Programming Interface (API) calls (e.g., as provided by OPENAI™ or other publicly available Artificial Intelligence (AI) service providers). For example, model component 112 may obtain a reply “The driver's name is JANICE SAMPLE. The driver's date of birth is Jan. 12, 1967.” from large language model 133, accompanied by a set of probabilities that correspond to the set of tokens in this reply. Assuming, for the sake of this example, each alphanumerical character is a separate token, this reply includes a set of 84 characters, including spaces and punctuation. Accordingly, model component 112 may also obtain a set of 84 probabilities, corresponding to the set of 84 tokens in this reply. In some cases, individual probabilities are expressed as a percentage between 0-100%. For example, the set of six tokens that spell “JANICE” may correspond to a set of six probabilities that is [95%, 94%, 94%, 90%, 93%, 95%]. For example, the set of six tokens that spell “SAMPLE” may correspond to a set of six probabilities that is [90%, 92%, 93%, 94%, 96%, 96%].

Token analyzer component 114 may be configured to determine subsets of tokens that correspond to particular items, e.g., items of information. Token analyzer component 114 may determine individual subsets of tokens that correspond to individual items as requested in queries from users. For example, using a particular driver's license (shown in FIG. 4) as context, a particular query may request the driver's name and date of birth: “What is the driver's name and date of birth?” This particular query requests a first item of information (i.e., the driver's name) and a second item of information (i.e., the driver's date of birth). Token analyzer component 114 may determine a first subset of tokens that correspond to the first item of information, and a second subset of tokens that correspond to the second item of information. For example, assuming the reply is “The driver's name is JANICE SAMPLE. The driver's date of birth is Jan. 12, 1967.” token analyzer component 114 may determine that the subset of tokens that spell “JANICE SAMPLE” correspond to the first item of information as requested in the user query. Additionally, token analyzer component 114 may determine that the subset of tokens that spell “Jan. 12, 1967” correspond to the second item of information as requested in the user query. Token analyzer component 114 may determine that other tokens in the set of 84 characters do not (directly) correspond to any of the requested information. In some cases, spaces and/or punctuation may be excluded from the determined subsets. For example, the first subset of tokens may spell “JANICE”, and “SAMPLE”, and the second subset of tokens may spell “January”, “12”, and “1967”.

Score component 116 may be configured to determine metrics and/or scores, e.g., confidence scores, for replies, based on probabilities for certain tokens in those replies. Score component 116 may determine confidence scores for parts of replies, such as certain information in replies. Score component 116 may determine a confidence score for a (sub)set of tokens in a particular reply from large language model 133. For example, score component 116 may determine a first confidence score for a first item of information as requested in a user query, a second confidence score for a second item of information as requested in the user query, and so forth. For example, using a particular driver's license (shown in FIG. 4) as context, a particular user query may request the driver's name and date of birth: “What is the driver's name and date of birth?” Score component 116 may determine a first confidence score (for the first subset of tokens that spell “JANICE SAMPLE”) based on the corresponding probabilities of the first subset of tokens. Additionally, score component 116 may determine a second confidence score (for the second subset of tokens that spell “Jan. 12, 1967”) based on the corresponding probabilities of the second subset of tokens. In some implementations, score component 114 may determine confidence scores by aggregating individual probabilities for individual tokens. By way of non-limiting example, the first confidence score may be determined by averaging the probabilities of the twelve tokens that spell “JANICE” and “SAMPLE”, such that the first confidence score is 93.5% (i.e., the average of 95%, 94%, 94%, 90%, 93%, 95%, and 90%, 92%, 93%, 94%, 96%, 96%). Other mathematical procedures to calculate an individual confidence score from a set of probabilities are envisioned within the scope of this disclosure.

Presentation component 118 may be configured to effectuate presentations to users, e.g., presentations of replies and/or other information. In some implementations, presentation component may present a presentation through user interface 128 on client computing platform 104. A particular presentation may include a particular reply (such as a particular item of requested information), a corresponding confidence score that corresponds to the particular reply (e.g., that corresponds to the particular item of requested information, that is, the subset of tokens as determined for that particular item of requested information), and/or other information.

Storage component 120 may be configured to store and retrieve information, e.g., in and from electronic storage 122. For example, storage component 120 may store electronic source documents 123 in electronic storage 122. For example, storage component 120 may retrieve a particular electronic source document 123 from electronic storage 122, as needed for operations by system 100.

In the example of a query “What is the two year CAGR for Example Company's revenue,” a sequence of steps may be determined (e.g., by large language model 133) for assisting one or more machine learning models 134 to generate the reply. For example, the sequence of steps may include a document search for Example Company's revenue for the past two years, a page retrieval based on a result of the document search, a calculation of the CAGR based on results of the page retrieval, and/or other steps. For example, a document search may yield summaries and identifications of sections of a document determined by one or more large language models 133 and/or a retrieval tool to include information pertaining to one of the steps. For example, the page retrieval may yield individual pages from a document provided as context for one of the steps based on the sections identified by the document search. For example, the calculation of the CAGR may include a calculation involving one or more values included in the individual pages yielded by the page retrieval using a calculator tool. For example, the calculator tool may be used to validate a CAGR value explicitly denoted in one or more documents 123. For example, the calculator tool may be used because the two-year CAGR is not explicitly denoted in one or more documents 123.

In some cases, the information requested in a user query is literally found verbatim in a source document. Such a query is sometimes referred to as requiring “text extraction”. For example, using a particular driver's license as context, this query requires text extraction: “What is the driver's name?” In other cases, the information requested in a user query is not found verbatim in a source document, but can be logically inferred from the content of a source document (perhaps in combination with other information). Such a query is sometimes referred to as requiring reasoning. For example, using a particular driver's license as context, this query requires reasoning: “How many months ago was the driver's birthday?”

For queries requiring reasoning, prompt component 110 may be configured to generate additional prompt information defining additional prompts. The additional prompt information requests a set of additional replies to a set of additional questions for one or more machine learning models 134. The set of additional questions pertain the previously-provided reply to the previously-provided user query requiring reasoning. In some cases, additional questions are formatted as YES/NO questions, such that one or more machine learning models 134 can reply to each additional question with a single “YES” or “NO” (or equivalent phrases such as “TRUE” and “FALSE” or “1” and “0”). For example, an additional question may be:
“Does the response contain a factual answer to the given question?” For example, an additional question may be: “Is there information requested in the question that is omitted in the response?” For queries requiring reasoning, prompt component 110 may be configured to provide the additional prompt information to one or more machine learning models 134. The set of additional replies may be obtained by model component 112. The set of additional replies includes additional tokens. In some cases, depending on the formatting of the additional questions, the additional replies include a single token (either “YES” or “NO”) per reply. Each additional token is associated with a probability (referred to as the additional probability).

For queries requiring reasoning, score component 116 may be configured to determine a particular confidence score based on the probabilities of the additional tokens for a set of additional questions. For example, a set of four additional questions may have four additional tokens, and four additional probabilities. The particular confidence score may be based on these four additional probabilities, e.g., by aggregating the four additional probabilities. Presentation component 118 may present this particular confidence score for a query requiring reasoning.

In some implementations, server(s) 102, client computing platform(s) 104, and/or external resources 140 may be operatively linked via one or more electronic communication links. For example, such electronic communication links may be established, at least in part, via one or more networks 13 such as the Internet and/or other networks. It will be appreciated that this is not intended to be limiting, and that the scope of this disclosure includes implementations in which server(s) 102, client computing platform(s) 104, and/or external resources 140 may be operatively linked via some other communication media.

A given client computing platform 104 may include one or more processors configured to execute computer program components. The computer program components may be configured to enable an expert or user associated with the given client computing platform 104 to interface with system 100 and/or external resources 140, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

User interfaces 128 may be configured to facilitate interaction between users 127 and system 100 and/or between users 127 and client computing platforms 104. For example, user interfaces 128 may provide an interface through which users may provide information to and/or receive information from system 100. In some implementations, user interface 128 may include one or more of a display screen, touchscreen, monitor, a keyboard, buttons, switches, knobs, levers, mouse, microphones, sensors to capture voice commands, sensors to capture eye movement and/or body movement, sensors to capture hand and/or finger gestures, and/or other user interface devices configured to receive and/or convey user input. In some implementations, one or more user interfaces 128 may be included in one or more client computing platforms 104. In some implementations, one or more user interfaces 128 may be included in system 100.

External resources 140 may include sources of information outside of system 100, external entities participating with system 100, and/or other resources. In some implementations, external resources 140 may include a provider of documents, including but not limited to electronic documents 123, from which system 100 and/or its components (e.g., source component 108) may obtain documents. In some implementations, external resources 140 may include a provider of information and/or models, including but not limited to extracted information 125, model(s) 134, and/or other information from which system 100 and/or its components may obtain information and/or input. In some implementations, some or all of the functionality attributed herein to external resources 140 may be provided by resources included in system 100.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102. In some implementations, some or all of the functionality attributed herein to server 102 and/or system 100 may be provided by resources included in one or more client computing platform(s) 104.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store electronic source documents 123, software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. Processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute components 108, 110, 112, 114, 116, 118, 120, and/or other components. Processor(s) 124 may be configured to execute components 108, 110, 112, 114, 116, 118, 120, and/or other components by software; hardware; firmware; some combination of software, hardware, and/or firmware; and/or other mechanisms for configuring processing capabilities on processor(s) 124. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, and/or 120 are illustrated in FIG. 1 as being implemented within a single processing unit, in implementations in which processor(s) 124 includes multiple processing units, one or more of components 108, 110, 112, 114, 116, 118, and/or 120 may be implemented remotely from the other components. The description of the functionality provided by the different components 108, 110, 112, 114, 116, 118, and/or 120 described below is for illustrative purposes, and is not intended to be limiting, as any of components 108, 110, 112, 114, 116, 118, and/or 120 may provide more or less functionality than is described. For example, one or more of components 108, 110, 112, 114, 116, 118, and/or 120 may be eliminated, and some or all of its functionality may be provided by other ones of components 108, 110, 112, 114, 116, 118, and/or 120. As another example, processor(s) 124 may be configured to execute one or more additional components that may perform some or all of the functionality attributed below to one of components 108, 110, 112, 114, 116, 118, and/or 120.

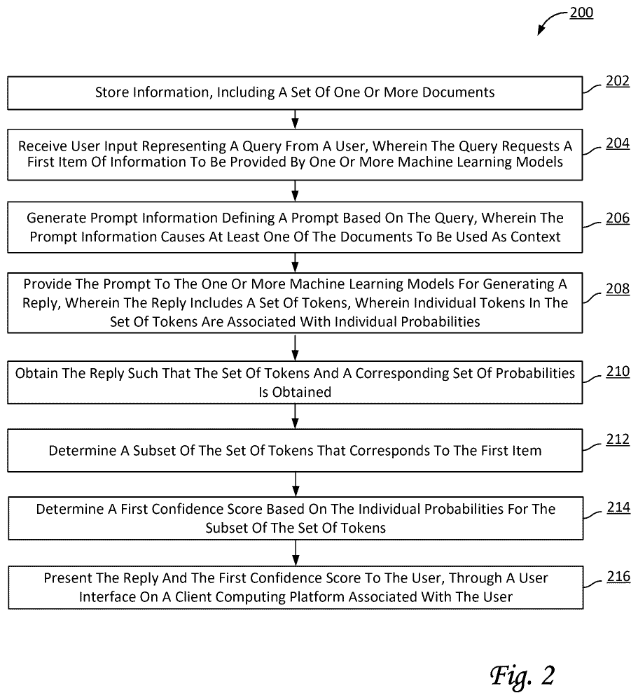

FIG. 2 illustrates a method 200 of producing confidence scores for replies from one or more machine learning models, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, information is stored. The stored information includes a set of one or more documents. In some embodiments, operation 202 is performed by a storage component the same as or similar to storage component 120 (shown in FIG. 1 and described herein).

At an operation 204, user input is received representing a query from a user. The query requests a first item of information to be provided by the one or more machine learning models using at least one of the one or more documents as context. In some embodiments, operation 204 is performed by a query receiving component the same as or similar to query receiving component 108 (shown in FIG. 1 and described herein).

At an operation 206, prompt information is generated defining a prompt, based on the query. The prompt information causes at least one of the one or more documents to be used as context by the one or more machine learning models. In some embodiments, operation 206 is performed by a prompt component the same as or similar to prompt component 110 (shown in FIG. 1 and described herein).

At an operation 208, the prompt is provided as input to one or more machine learning models. The one or more machine learning models are configured to generate a reply to the prompt. The reply includes a set of tokens. Individual tokens in the set of tokens are associated with individual probabilities of having been generated by the one or more machine learning models. In some embodiments, operation 208 is performed by a prompt component the same as or similar to prompt component 110 (shown in FIG. 1 and described herein).

At an operation 210, the reply to the prompt is obtained, from the one or more machine learning models, such that the set of tokens is obtained, and further such that a corresponding set of probabilities is obtained that corresponds to the set of tokens. In some embodiments, operation 210 is performed by a model component the same as or similar to model component 112 (shown in FIG. 1 and described herein).

At an operation 212, a subset is determined of the set of tokens that corresponds to the first item. In some embodiments, operation 212 is performed by a token analyzer component the same as or similar to token analyzer component 114 (shown in FIG. 1 and described herein).

At an operation 214, a first confidence score is determined based on the individual probabilities for the subset of the set of tokens. In some embodiments, operation 214 is performed by a score component the same as or similar to score component 116 (shown in FIG. 1 and described herein).

At an operation 216, a presentation of the reply is effectuated to the user, through a user interface on a client computing platform associated with the user. The reply includes the first item. The presentation presents the first confidence score. In some embodiments, operation 216 is performed by a presentation component the same as or similar to presentation component 118 (shown in FIG. 1 and described herein).

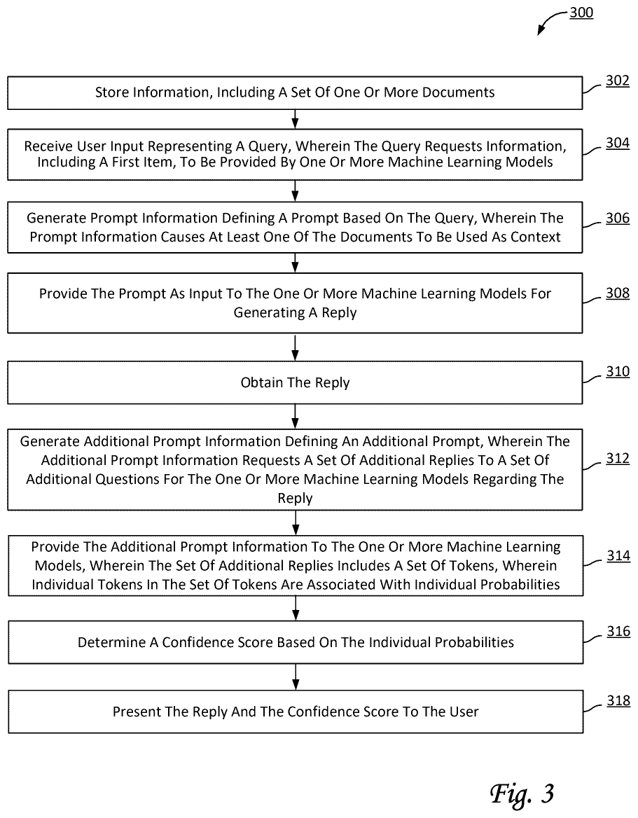

FIG. 3 illustrates a method 300 of producing confidence scores for replies from one or more machine learning models, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, information is stored. The stored information includes a set of one or more documents. In some embodiments, operation 302 is performed by a storage component the same as or similar to storage component 120 (shown in FIG. 1 and described herein).

At an operation 304, user input is received representing a query from one or more client computing platforms. The query requests information to be provided by the one or more machine learning models using at least one of the one or more documents as context. The information include at least a first item. In some embodiments, operation 304 is performed by a query receiving component the same as or similar to query receiving component 108 (shown in FIG. 1 and described herein).

At an operation 306, prompt information is generated defining a prompt based on the query. The prompt information causes at least one of the one or more documents to be used as context by the one or more machine learning models. In some embodiments, operation 306 is performed by a prompt component the same as or similar to prompt component 110 (shown in FIG. 1 and described herein).

At an operation 308, the prompt is provided as input to one or more machine learning models to generate a reply to the prompt. In some embodiments, operation 308 is performed by a prompt component the same as or similar to prompt component 110 (shown in FIG. 1 and described herein).

At an operation 310, the reply to the prompt is obtained. In some embodiments, operation 310 is performed by a model component the same as or similar to model component 112 (shown in FIG. 1 and described herein).

At an operation 312, additional prompt information is generated defining an additional prompt. The additional prompt information requests a set of additional replies to a set of additional questions for the one or more machine learning models regarding the reply as previously generated by the one or more machine learning models. In some embodiments, operation 312 is performed by a prompt component the same as or similar to prompt component 110 (shown in FIG. 1 and described herein).

At an operation 314, the additional prompt information is provided to the one or more machine learning models to generate the set of additional replies to the additional prompt. The set of additional replies includes a set of tokens. Individual tokens in the set of tokens are associated with individual probabilities of having been generated by the one or more machine learning models. In some embodiments, operation 314 is performed by a prompt component the same as or similar to prompt component 110 (shown in FIG. 1 and described herein).

At an operation 316, a confidence score is determined based on the individual probabilities. In some embodiments, operation 316 is performed by a score component the same as or similar to score component 116 (shown in FIG. 1 and described herein).

At an operation 318, a presentation of the reply is effectuated to the user, through a user interface on the one or more client computing platforms. The reply includes the first item. The presentation presents the confidence score. In some embodiments, operation 318 is performed by a presentation component the same as or similar to presentation component 118 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to produce confidence scores for replies from one or more machine learning models, the system comprising:
electronic storage configured to electronically store information, wherein the stored information includes a set of one or more documents; and
one or more hardware processors configured by machine readable instructions to:
receive user input representing a query from a user, wherein the query requests a first item of information to be provided by the one or more machine learning models using at least one of the one or more documents as context;
generate prompt information defining a prompt based on the query, wherein the prompt information causes at least one of the one or more documents to be used as context by the one or more machine learning models;
provide the prompt as input to the one or more machine learning models, wherein the one or more machine learning models are configured to generate a reply to the prompt, wherein the reply includes a set of tokens, wherein individual tokens in the set of tokens are associated with individual probabilities of having been generated by the one or more machine learning models;
obtain, from the one or more machine learning models, the reply to the prompt such that the set of tokens is obtained, and further such that a corresponding set of probabilities is obtained that corresponds to the set of tokens;
determine a subset of the set of tokens that corresponds to the first item;
determine a first confidence score based on the individual probabilities for the subset of the set of tokens; and
effectuate a presentation of the reply to the user, through a user interface on a client computing platform associated with the user, wherein the reply includes the first item, and wherein the presentation presents the first confidence score.

2. The system of claim 1, wherein the one or more hardware processors are further configured to effectuate a particular presentation to the user, through the user interface on the client computing platform, wherein the particular presentation depicts content of at least some of the set of one or more documents, and wherein the user input is received from the user using the user interface.

3. The system of claim 1, wherein the prompt information specifies that the individual probabilities for the individual tokens in the set of tokens are to be included in the reply by the one or more machine learning models.

4. The system of claim 1, wherein the one or more machine learning models include a large language model that has been trained on at least a million documents, and wherein the large language model includes a neural network using over a billion parameters and/or weights.

5. The system of claim 1, wherein the large language model is based on Generative Pre-trained Transformer 3 (GPT3) or a successor of Generative Pre-trained Transformer 3 (GPT3).

6. The system of claim 1, wherein the query further requests a second item of information to be provided by the one or more machine learning models, wherein the one or more hardware processors are further configured to:
determine a second subset of the set of tokens that corresponds to the second item; and
determine a second confidence score based on the individual probabilities for the second subset of the set of tokens, wherein the second confidence score is different from the first confidence score,
wherein the reply further includes the second item, and wherein the presentation further presents the second confidence score.

7. The system of claim 1, wherein determining the first confidence score includes aggregating the individual probabilities for the subset of the set of tokens.

8. The system of claim 1, wherein the reply includes information that indicates the one or more machine learning models used logical inference to generate the reply, wherein the one or more hardware processors are further configured to:
generate additional prompt information defining an additional prompt, wherein the additional prompt information requests a set of additional replies to a set of additional questions for the one or more machine learning models regarding the reply as previously generated by the one or more machine learning models;
provide the additional prompt information to the one or more machine learning models, wherein the one or more machine learning models are configured to generate the set of additional replies to the additional prompt, wherein the set of additional replies includes an additional set of tokens, wherein individual tokens in the additional set of tokens are associated with individual additional probabilities of having been generated by the one or more machine learning models;
determine an additional confidence score based on the individual additional probabilities; and
effectuate an additional presentation to the user, wherein the additional presentation presents the additional confidence score.

9. The system of claim 1, wherein individual ones of the additional questions are formatted such that corresponding additional replies represent either “YES” or “NO”.

10. The system of claim 1, wherein the additional confidence score is based on aggregating the individual additional probabilities.

11. A method of producing confidence scores for replies from one or more machine learning models, the method comprising:
electronically storing information, wherein the stored information includes a set of one or more documents;
receiving user input representing a query from a user, wherein the query requests a first item of information to be provided by the one or more machine learning models using at least one of the one or more documents as context;
generating prompt information defining a prompt based on the query, wherein the prompt information causes at least one of the one or more documents to be used as context by the one or more machine learning models;
providing the prompt as input to the one or more machine learning models, wherein the one or more machine learning models are configured to generate a reply to the prompt, wherein the reply includes a set of tokens, wherein individual tokens in the set of tokens are associated with individual probabilities of having been generated by the one or more machine learning models;
obtaining, from the one or more machine learning models, the reply to the prompt such that the set of tokens is obtained, and further such that a corresponding set of probabilities is obtained that corresponds to the set of tokens;
determining a subset of the set of tokens that corresponds to the first item;
determining a first confidence score based on the individual probabilities for the subset of the set of tokens; and
effectuating a presentation of the reply to the user, through a user interface on a client computing platform associated with the user, wherein the reply includes the first item, and wherein the presentation presents the first confidence score.

12. The method of claim 11, further comprising:
effectuating a particular presentation to the user, through the user interface on the client computing platform, wherein the particular presentation depicts content of at least some of the set of one or more documents, and wherein the user input is received from the user using the user interface.

13. The method of claim 11, wherein the prompt information specifies that the individual probabilities for the individual tokens in the set of tokens are to be included in the reply by the one or more machine learning models.

14. The method of claim 11, wherein the one or more machine learning models include a large language model that has been trained on at least a million documents, and wherein the large language model includes a neural network using over a billion parameters and/or weights.

15. The method of claim 11, wherein the large language model is based on Generative Pre-trained Transformer 3 (GPT3) or a successor of Generative Pre-trained Transformer 3 (GPT3).

16. The method of claim 11, wherein the query further requests a second item of information to be provided by the one or more machine learning models, the method further comprising:
determining a second subset of the set of tokens that corresponds to the second item; and
determining a second confidence score based on the individual probabilities for the second subset of the set of tokens, wherein the second confidence score is different from the first confidence score, wherein the reply further includes the second item, and wherein the presentation further presents the second confidence score.

17. The method of claim 11, wherein determining the first confidence score includes aggregating the individual probabilities for the subset of the set of tokens.

18. The method of claim 11, wherein the reply includes information that indicates the one or more machine learning models used logical inference to generate the reply, the method further comprising:
generating additional prompt information defining an additional prompt, wherein the additional prompt information requests a set of additional replies to a set of additional questions for the one or more machine learning models regarding the reply as previously generated by the one or more machine learning models;
providing the additional prompt information to the one or more machine learning models, wherein the one or more machine learning models generate the set of additional replies to the additional prompt, wherein the set of additional replies includes an additional set of tokens, wherein individual tokens in the additional set of tokens are associated with individual additional probabilities of having been generated by the one or more machine learning models;
determining an additional confidence score based on the individual additional probabilities; and
effectuating an additional presentation to the user, wherein the additional presentation presents the additional confidence score.

19. A system configured to produce confidence scores for replies from one or more machine learning models, the system comprising:
electronic storage configured to electronically store information, wherein the stored information includes a set of one or more documents; and
one or more hardware processors configured by machine readable instructions to:
receive user input representing a query from one or more client computing platforms, wherein the query requests information to be provided by the one or more machine learning models using at least one of the one or more documents as context, wherein the information include at least a first item;
generate prompt information defining a prompt based on the query, wherein the prompt information causes at least one of the one or more documents to be used as context by the one or more machine learning models;
provide the prompt as input to one or more machine learning models, wherein the one or more machine learning models are configured to generate a reply to the prompt;
obtain, from the one or more machine learning models, the reply to the prompt;
generate additional prompt information defining an additional prompt, wherein the additional prompt information requests a set of additional replies to a set of additional questions for the one or more machine learning models regarding the reply as previously generated by the one or more machine learning models;
provide the additional prompt information to the one or more machine learning models, wherein the one or more machine learning models are configured to generate the set of additional replies to the additional prompt, wherein the set of additional replies includes a set of tokens, wherein individual tokens in the set of tokens are associated with individual probabilities of having been generated by the one or more machine learning models;
determine a confidence score based on the individual probabilities into a confidence score; and
effectuate a presentation of the reply to the user, through a user interface on the one or more client computing platforms, wherein the reply includes the first item, and wherein the presentation presents the confidence score.

20. A method of producing confidence scores for replies from one or more machine learning models, the method comprising:
electronically storing information, wherein the stored information includes a set of one or more documents;
receiving user input representing a query from one or more client computing platforms, wherein the query requests information to be provided by the one or more machine learning models using at least one of the one or more documents as context, wherein the information include at least a first item;
generating prompt information defining a prompt based on the query, wherein the prompt information causes at least one of the one or more documents to be used as context by the one or more machine learning models;
providing the prompt as input to one or more machine learning models to generate a reply to the prompt;
obtaining the reply to the prompt;
generating additional prompt information defining an additional prompt, wherein the additional prompt information requests a set of additional replies to a set of additional questions for the one or more machine learning models regarding the reply as previously generated by the one or more machine learning models;
providing the additional prompt information to the one or more machine learning models to generate the set of additional replies to the additional prompt, wherein the set of additional replies includes a set of tokens, wherein individual tokens in the set of tokens are associated with individual probabilities of having been generated by the one or more machine learning models;
determining a confidence score based on the individual probabilities; and
effectuating a presentation of the reply to the user, through a user interface on the one or more client computing platforms, wherein the reply includes the first item, and wherein the presentation presents the confidence score.
